(19) United States
(12) Patent Application Publication
(10) Pub. No.: US 2006/0109684 A1
(43) Pub. Date: May 25, 2006

(54) Backlight unit

(75) Inventors: Dmitry Nesterenko, Suwon-si (KR); Hwan-young Choi, Anyang-si (KR); Moon-gyu Lee, Suwon-si (KR); Jee-hong Min, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/283,780

(22) Filed: Nov. 22, 2005

(30) Foreign Application Priority Data
Nov. 22, 2004 (KR) 10-2004-0095902

(51) Int. Cl. F21V 7/04

(52) U.S. Cl. 362/610; 362/609; 362/621

(57) ABSTRACT

A backlight unit including at least one light source that emits light, a light guide panel guiding light that is incident to a side surface thereof, a light incident portion, which protrudes to be inclined with respect to the side surface of the light guide panel, and which has third and fourth light incident surfaces on which light is incident, and first and second guide members which are arranged to face the third and fourth light incident surfaces, respectively, and which guide the light that is emitted from the light source to be incident on each of the third and fourth light incident surfaces, wherein an air gap is formed between each of the third and fourth light incident surfaces and each of the first and second guide members.

### BACKGROUND OF THE INVENTION

This application claims priority from Korean Patent Application No. 10-2004-0095902, filed on Nov. 22, 2004, in the Korean Intellectual Property Office, the disclosure of which is incorporated herein in its entirety by reference.

1. Field of the Invention

Apparatuses consistent with the present invention relate to an edge light type backlight unit, and more particularly, to a backlight unit having a light incident portion which is improved to narrow an incident angle of a beam emitted from a light source.

2. Description of the Related Art

Typically, a liquid crystal display device, which is a type of light receiving flat panel display, forms an image by receiving light from the outside, and not by directly emitting light for itself. Accordingly, a backlight unit for emitting light is installed on a rear surface of the liquid crystal display device. A backlight unit is used not only for liquid crystal display devices, but also for a surface light source devices such as an illumination signboard.

Backlight units are classified into direct light types and edge light types according to the arrangement of a light source. In the direct light type backlight unit, a lamp installed just under a liquid crystal panel directly emits light toward the liquid crystal panel. In the edge light type backlight unit, a lamp installed at an edge of a light guide panel (LGP) emits light and the emitted light is transferred to the liquid crystal panel via the LGP.

The edge light type backlight unit may use a linear light source or a point light source. A typical linear light source is a cold cathode fluorescent lamp (CCFL), in which electrodes of both end portions are installed in a tube. The point light source includes, for example, a light emitting diode (LED).

The CCFL can radiate a strong white light with a high luminance and a high uniformity and enables a large-size design. However, the CCFL is disadvantageous in that it is operated by a high frequency alternating current (AC) signal and the operating temperature range is narrow. Further, the performance of the LED is inferior in luminance and uniformity, compared to the CCFL. However, the LED is advantageous in that it is operated by a direct current (DC) signal, has a long light span, has a wide operating temperature range, and can be made compact.

The LGP which is used in the edge light type backlight unit converts a light, which is emitted from a light source and input through an edge of the liquid crystal panel, to a surface light which is to be output in a vertical direction. A dispersion pattern or a hologram pattern to convert the light output from the light source to surface light is formed on the LGP in a print method or a mechanical processing method.

FIG. 1 is a perspective view of a conventional edge light type backlight unit using a point light source. FIG. 2 is a cross-sectional view of the edge light type backlight unit of FIG. 1. FIG. 3 is a graph showing an azimuth angle of an LED used in the edge light type backlight unit of FIG. 1.

Referring to FIG. 1, FIG. 2, and FIG. 3, three LEDs 20 are installed at an edge 11 of the LGP 10 as point light sources. A hologram pattern 30 for allowing light output from the LEDs 20 to proceed toward a light output surface 12 is formed on a lower surface of the LGP 10. The LEDs 20 emit light toward the edge 11 of the LGP 10. Since the LEDs 20 are point light sources, as shown in FIG. 3, each LED emits light in an azimuth angle of ±90° with respect to an optical axis. An azimuth angle at which a light is emitted having an intensity corresponding to half of the maximum value Iₘₐₓ of the light intensity is referred to as a half-power angle. The half-power angle of the LED is normally about ±45°.

The lights emitted from the LEDs 20 are input to the LGP 10 through the edge 11. The hologram pattern 30, which has a diffractive grating structure, converts incident light to surface light and allows the light to proceed toward the light output surface 12, which is an upper surface of the LGP 10. The hologram pattern 30 has a particular orientation.

Also, as an incident azimuth angle distribution of the light that is incident on the hologram pattern 30 decreases, a uniform luminance can be obtained at the light output surface 12. When the luminance of the light output surface 12 is not uniform, a screen appears to be smeared. A change of about 0.9 in luminance is detected as a smear in a narrow range of about 1 cm. When the luminance change is gradually generated from the center portion of a screen to the edge thereof, even if the luminance change is 0.8, luminance smear is not detected. Thus, a luminance uniformity of at least 0.8 is required and, to obtain a high quality image, a luminance uniformity of 0.9 or more is required.

FIG. 4 is a plan view of the edge light type backlight unit of FIG. 1, which shows the distribution of the light that is emitted through the light output surface 12 of the LGP 10. Referring to FIG. 4, the light output surface 12 is divided into three regions: a light incident portion 12a, a central portion 12b, and a large light portion 12c, which are positioned, in order, from the edge 11 where the LEDs 20 are installed. The distribution of output light that is emitted from the respective regions 12a, 12b, and 12c is the same as that shown in FIG. 4. That is, the central portion 12b and the large light portion 12c have a wider light output distribution, compared to the light incident portion 12a.

FIG. 5 is a graph showing the luminance of the light that is emitted from each of the regions of FIG. 4. The vertical axis denotes luminance while the horizontal axis denotes a light output angle presented with a full width half maximum (FWHM). Three curves C1, C2, and C3 indicate the luminance of the light incident portion 12a, the central portion 12b, and the large light portion 12c, respectively. Referring to FIG. 5, FIG. 5 shows that the luminance at the light incident portion 12a is greater than the luminance at the central portion 12b and the large light portion 12c. Also, FIG. 5 shows that the FWHM of 20°/20° at the light incident portion 12a increases to 20°/35° at the central portion 12b and the large light portion 12c. In the indication of the FWHM, the values before and after a sign “/” denote the FWHM in the X direction and the FWHM in the Y direction, as shown in FIG. 4, respectively.

The difference in luminance in the respective regions results from the distribution of the incident azimuth angle of the light that is incident on the hologram pattern 30 at the central portion 12b or the large light portion 12c is greater than that at the light incident portion 12a. This is because, at the central portion 12b and the large light portion 12c, the light is input to the hologram pattern 30 with various incident azimuth angles after being reflected several times as shown in FIG. 2. This irregularity in luminance becomes severe as the incident azimuth angle of the light that is emitted from the LEDs 20, and input to the LGP 10, increases.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above

To solve the above and/or other problems, an exemplary embodiment of the present invention provides an edge light type backlight unit, which can improve uniformity in luminance of the light output surface by decreasing an azimuth angle of the light emitted from the light source and input to the LGP.

According to an aspect of the present invention, a backlight unit comprises at least one light source emitting light, a light guide panel guiding the proceeding of light incident to a side surface thereof, a light incident portion protruding to be inclined with respect to the side surface of the light guide panel and having first and second light incident surfaces on which light is incident, and first and second guide members arranged to face the first and second light incident surfaces, respectively, and guiding the light emitted from the light source to be incident on each of the first and second light incident surfaces, wherein an air gap is formed between each of the first and second light incident surfaces and each of the first and second guide members.

According to another aspect of the present invention, a backlight unit comprises at least one light source emitting light, a light guide panel guiding the proceeding of light incident to a side surface thereof, a light incident portion protruding to be inclined with respect to the side surface of the light guide panel and having first and second light incident surfaces arranged to be separated a predetermined distance from each other, and a guide portion integrally formed with the light incident portion via a connection portion between the first and second light incident surfaces, arranged to face each other by being separated a predetermined air gap with respect to each of the first and second light incident surfaces, and guiding the light emitted from the light source to be incident on the light guide panel.

According to yet another aspect of the present invention, a backlight unit comprises at least one light source emitting light, a light guide panel guiding the proceeding of light incident to a side surface thereof, a light incident portion protruding to be inclined with respect to the side surface of the light guide panel and having first and second light incident surfaces arranged to be separated a predetermined distance from each other, a guide portion integrally formed with the light incident portion and arranged to face each of the first and second light incident surfaces by being separated a predetermined distance therefrom, and guiding the light emitted from the light source to be incident on the light guide panel, and first and second reflective members, each having a first reflective portion formed on an outer side of the guide portion and a second reflective portion disposed on an outer side of a gap between each of the first and second light incident surfaces and the guide portion.

### BRIEF DESCRIPTION OF THE DRAWINGS

The above and other features and advantages of the present invention will become more apparent by describing in detail exemplary embodiments thereof with reference to the attached drawings, in which:

FIG. 1 is a perspective view of a conventional edge light type backlight unit using a point light source;

FIG. 2 is a cross-sectional view of the edge light type backlight unit of FIG. 1;

FIG. 3 is a graph showing an azimuth angle of the LED used in the edge light type backlight unit of FIG. 1;

FIG. 4 is a plan view of the edge light type backlight unit of FIG. 1, showing the distribution of the light that is emitted through the light output surface 12 of the LGP 10;

FIG. 5 is a graph showing the luminance of the light that is emitted from each of the regions of FIG. 4;

FIG. 6 is a perspective view of a backlight unit according to a first exemplary embodiment of the present invention;

FIG. 7 is a perspective view illustrating a part of the backlight unit of FIG. 6;

FIG. 8 is a plan view of the part of the backlight unit of FIG. 7;

FIG. 9 is a perspective view illustrating a part of a backlight unit according to a second exemplary embodiment of the present invention;

FIG. 10 is a plan view of the part of the backlight unit of FIG. 9;

FIG. 11 a perspective view illustrating a part of a backlight unit according to a third exemplary embodiment of the present invention;

FIG. 12 is a plan view of the part of the backlight unit of FIG. 11;

FIG. 13A, FIG. 13B, FIG. 13C and FIG. 13D are images showing a collimating performance of the backlight units according the first, second and third exemplary embodiments of the present invention and a comparative example; and

FIG. 14A and FIG. 14B are graphs showing the uniformity of the comparative example and the backlight units according to the third exemplary embodiment of the present invention.

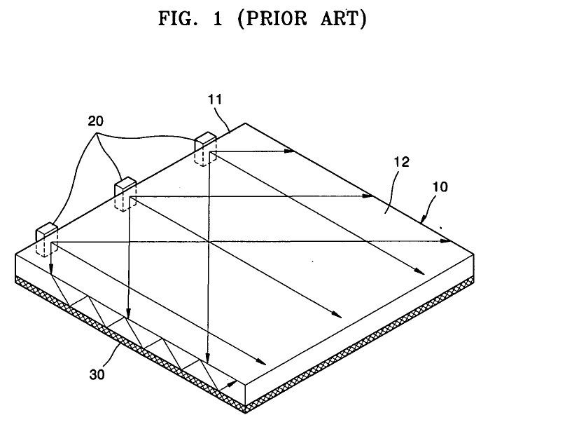

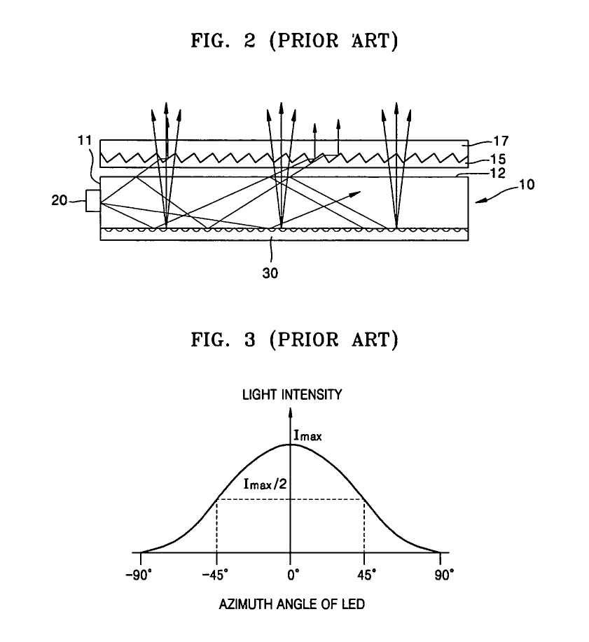

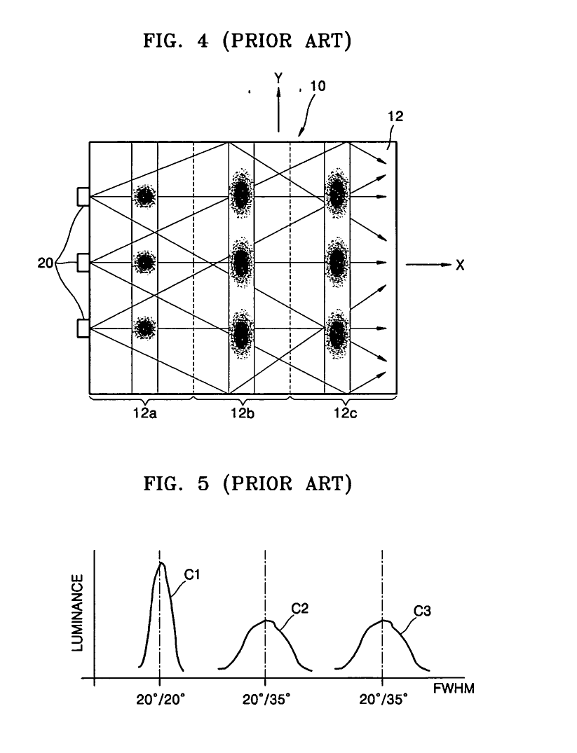

### DETAILED DESCRIPTION OF EXEMPLARY EMBODIMENTS OF THE INVENTION

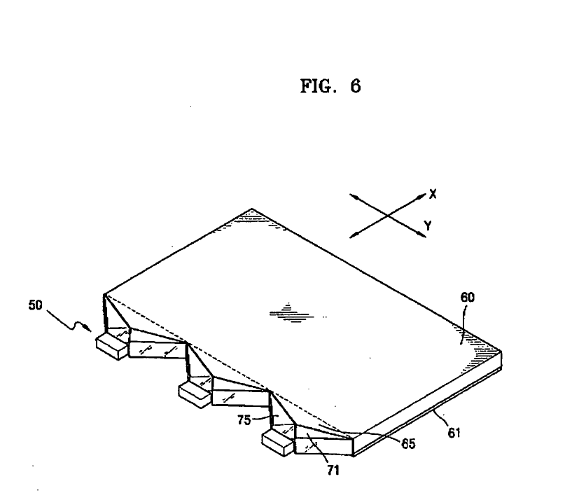

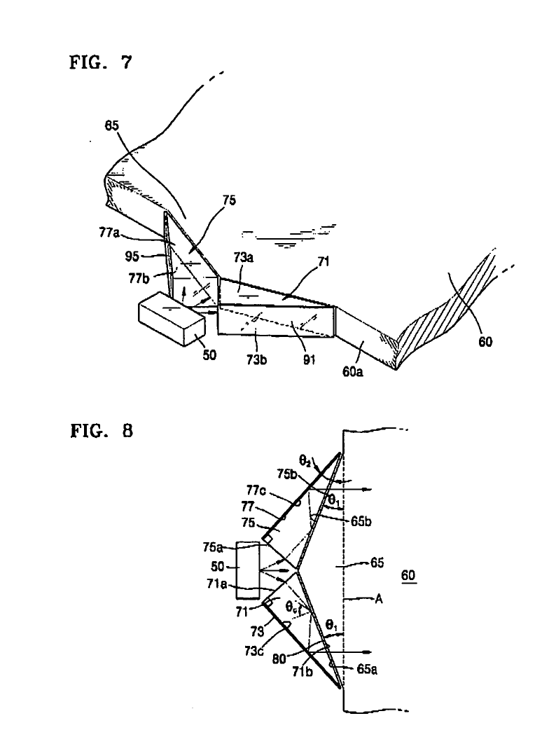

FIG. 6 is a perspective view of a backlight unit according to a first exemplary embodiment of the present invention. FIG. 7 and FIG. 8 are a perspective view and a plan view of a part of the backlight unit of FIG. 6, respectively.

Referring to FIG. 6, FIG. 7 and FIG. 8, a backlight unit according to a first exemplary embodiment of the present invention includes at least one light source 50, a light guide panel 60 for guiding light incident from one side surface, a light incident portion 65 provided at a side surface of the light guide panel 60, and first and second guide members 71 and 75 provided between the light incident portion 65 and the light source 50.

The light source 50 may be a point light source, such as an LED, or a linear light source, such as a CCFL, and the light source 50 emits light to a side surface of the light guide panel 60. FIG. 6 shows an example in which three LEDs are used as light sources 50. As shown in FIG. 6, the light source 50, the light incident portion 65, and the first and second guide members 71 and 75 are provided so as to correspond to each of the LEDs. An LED emits light in a range of an azimuth angle of ±90° with respect to an optical axis thereof. The FWHM of an LED is about ±45°, as shown in FIG. 3.

Although, in the present exemplary embodiment, three light sources 50 are installed at a side of the light guide panel 60, the present invention is not limited thereto and other numbers of light sources can be used. That is, the number of the light sources 50 is dependent on the size of the light guide panel 60 and a required luminance so that a greater or lesser number than three of the light sources 50 can be provided.

As shown in FIG. 7, the light guide panel 60 guides the light incident from a side surface 60a and is formed of a transparent material, which can transmit an incident light. The light guide panel 60 is mainly formed of acryl-based transparent resin, for example, polymethylmeta acrylate (PMMA) having a refractive index of about 1.49 and a specific gravity of about 1.19, or of olefin-based transparent resin having a specific gravity of 1.0 for light weight. The light guide panel 60 has a flat panel structure having a thickness of about 2 mm to 3 mm. Also, a taper structure can be used in which the thickness of the light guide panel 60 gradually decreases as the light guide panel 60 is far from the light incident surface. The size of the light output surface of the light guide panel 60 is determined by the size of a flat surface of an image display device to which the light guide panel 60 is adopted.

A hologram pattern 61 for diffracting the light incident from a side surface thereof toward the light output surface can be formed on a lower surface of the light guide panel 60. The hologram pattern 61 is formed by repeatedly arranging a plurality of diffractive gratings having a period of 2 μm or less. For example, the hologram pattern 61 can have a structure in which a plurality of diffractive gratings having a period of 0.4 μm and a depth of 0.2 μm are repeatedly arranged. A reflection member (not shown) for reflecting the light upward can be installed under the hologram pattern 61. The luminance of light at the light output surface of the light guide panel 60 becomes uniform as the azimuth angle of the light that is incident on the hologram pattern 61 decreases and the distribution of the azimuth angel is uniform.

The light incident portion 65 and the first and second guide members 71 and 75 condense the light that is emitted from the light source 50 and input this condensed light to the light guide panel 60 to decrease the azimuth angle of the light in the light guide panel 60. The light incident portion 65 is formed of the same material as that of the light guide panel 60, which has the same refractive index as the light incident portion 65. Alternatively, the light incident portion 65 is integrally formed with the light guide panel 60.

For this purpose, the light incident portion 65 protrudes to be inclined with respect to the side surface 60a, on which the light of the light guide panel 60 is incident, and has third and fourth light incident surfaces 65a and 65b. An angle θ₁ between a segment A, which extends from the side surface 60a of the light guide panel 60 where the light incident portion 65 is formed, and each of the third and fourth light incident surfaces 65a and 65b is about 21°. This angle is set considering the direction of the light reflected by the first and second guide members 71 and 75 so as to condense the light incident to the light incident portion 65.

The first and second guide members 71 and 75 are arranged to face the third and fourth light incident surfaces 65a and 65b, respectively, and guide the light that is emitted from the light source 50 to be incident on the third and fourth light incident surfaces 65a and 65b. An air gap 80 is formed between the first guide member 71 and the third light incident surface 65a and between the second guide member 75 and the fourth light incident surface 65b. The air gap 80 is formed at a boundary surface between two facing members, that is, the first guide member 71 and the third light incident surface 65a, and the second guide member 75 and the fourth light incident surface 65b, which are arranged to contact each other without using an adhesive. When the air gap 80 is formed, the refractive indexes of the first and second guide members 71 and 75 are greater than that of air in the air gap 80. Thus, the light that is incident on surfaces facing the air gap 80, in the first and second guide members 71 and 75, which is incident at an angle greater than a critical angle θ_{c} is totally reflected. The direction in which the light proceeds can be guided by using this property.

The first and second guide members 71 and 75 include first and second light incident surfaces 71a and 75a, which are installed to face the light source 50, reflective surfaces 73 and 77, and light exit surfaces 71b and 75b. The light exit surfaces 71b and 75b are arranged to face the third and fourth light incident surfaces 65a and 65b, respectively. The light that is emitted from the light source 50 passes through the first and second light incident surfaces 71a and 75a and propagates in each of the first and second guide members 71 and 75. The reflective surfaces 73 and 77 reflect incident light to proceed toward the third and fourth light incident surfaces 65a and 65b. The light exit surfaces 71b and 75b reflect the light that is directly incident from the first and second light incident surfaces 71a and 75a and output the light that passes from the reflective surfaces 73 and 77 toward the light incident portion 65.

The reflective surfaces 73 and 77 include upper reflective surfaces 73a and 77a and lower reflective surfaces 73b and 77b, which are arranged to be separated a predetermined distance from each other and are arranged to face each other. Further, the reflective surfaces 73 and 77 include rear reflective surfaces 73c and 77c, which are arranged to be inclined with respect to the light exit surfaces 71b and 75b.

The distance between the respective upper reflective surfaces 73a and 77a and the respective lower reflective surfaces 73b and 77b is substantially the same as the thickness of the light guide panel 60. One side of each of the rear reflective surfaces 73c and 77c contacts each of the light first and second incident surfaces 71a and 75a, while the other side thereof contacts each of the light exit surfaces 71b and 75b.

Reflective members 91 and 95 are further provided on outer sides of the rear reflective surfaces 73c and 77c. The reflective members 91 and 95 reflect the incident light in the first and second guide members 71 and 75. By further providing the reflective members 91 and 95, the light that is incident on the rear reflective surfaces 73c and 77c, in the first and second guide members 71 and 75, can be totally reflected toward the light incident portion 65 regardless of an incident angle thereof. To this end, an angle θ₂ between each of the rear reflective surfaces 73c and 77c and each of the light exit surfaces 73a and 77a is about 21°.

When the angles θ₁ and θ₂ are set to be less than a predetermined value, the light proceeding to the light guide panel 60 is divergent so that a radiation angle increases. When the angles θ₁ and θ₂ are set to be greater than the predetermined value, the light reflected from the rear reflective surfaces 73c and 77c is reflected back to the light source 50 so that a light efficiency is lowered.

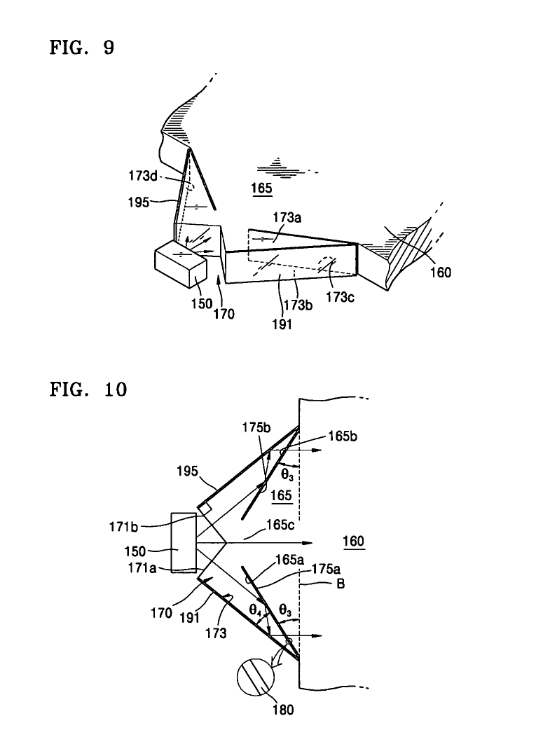

FIG. 9 and FIG. 10 are a perspective view and a plan view, respectively, illustrating major parts of a backlight unit according to a second exemplary embodiment of the present invention. Referring to FIG. 9 and FIG. 10, a backlight unit according to the second exemplary embodiment of the present invention includes at least one light source 150, a light guide panel 160 for guiding the light that is incident on one side surface thereof, a light incident portion 165 provided at one side surface of the light guide panel 160, and a guide portion 170 provided between the light incident portion 165 and the light source 150.

The light source 150 is a point light source, such as an LED, or a linear light source, such as a CCFL, which emits light to one side surface of the light guide panel 160. The light guide panel 160 guides the incident light. Since the light source 150 and the light guide panel 160 are substantially the same as the light source 50 of FIG. 7 and the light guide panel 60 of FIG. 7, according to the first exemplary embodiment of the present invention, detailed descriptions thereof will be omitted herein. A hologram pattern (not shown) for diffracting light incident from the side surface of the light guide panel 160 to proceed toward a light exit surface can be formed on a lower surface of the light guide panel 160.

The light incident portion 165 and the guide portion 170 condense the light that is emitted from the light source 150 and incident on the light guide panel 160 to decrease an azimuth angle of the light in the light guide panel 160.

To this end, the light incident portion 165 protrudes to be inclined with respect to one side of the light guide panel 160 on which light is incident and has third and fourth light incident surfaces 165a and 165b, respectively, which are arranged to be separated a predetermined distance from each other. An angle θ₃ between a segment B, which extends from the side surface of the light guide panel 160 where the light incident portion 165 is formed, and each of the third and fourth light incident surfaces 165a and 165b is about 32°. The angle is set considering the direction of the light reflected by the guide portion 170 so that the light that is incident on the light incident portion 165 is focused.

The guide portion 170 is integrally formed with the light incident portion 165 through a connection portion 165c, which is between the third light incident surface 165a and the fourth light incident surface 165b. The guide portion 170 is separated a predetermined distance, as wide as an air gap 180, from each of the third and fourth light incident surfaces 165a and 165b. Moreover, the guide portion 170 faces the third light incident surface 165a and the guide portion 170 also faces the fourth light incident surface 165b. The guide portion 170, configured as set forth above, guides the light that is emitted from the light source 150 to be incident on each of the third and fourth light incident surfaces 165a and 165b. The air gap 180 is formed at a boundary surface between two facing members when the guide portion 170 and each of the third and fourth light incident surfaces 165a and 165b are arranged to contact each other without using an additional adhesive. When the air gap 180 is formed as described above, the refractive index of the guide member 170 is greater than that of air in the air gap 180. Thus, the light that is incident on a surface of the guide member 170, which faces the air gap 180 at an angle that is greater than a critical angle is totally reflected. Thus, by reflecting the light incident at an angle greater than the critical angle, an efficiency of use of light can be improved.

The guide portion 170 includes first and second light incident surfaces 171a and 171b, respectively, which are installed to face the light source 150. The guide portion 170 also includes a reflective surface 173, and first and second light exit surfaces 175a and 175b. The first and second light exit surfaces 175a and 175b are arranged to face the third and fourth light incident surfaces 165a and 165b, respectively. The light that is emitted from the light source 150 passes through the first and second light incident surfaces 171a and 171b and propagates in the guide portion 170. The reflective surface 173 reflects the incident light so that it proceeds toward the third and fourth light incident surfaces 165a and 165b. The first and second light exit surface 175a and 175b reflect the light that is directly incident from the first and second light incident surfaces 171a and 171b and output the light that is incident via the reflection surface 173 toward the light incident portion 165. That is, the light that is directly incident from the first and second light incident surfaces 171a and 171b, which is incident at an angle greater than the critical angle with respect to each of the first and second light exit surfaces 175a and 175b, is totally reflected by the first and second light exit surfaces 175a and 175b due to a difference in the refractive index between the air gap 180 and the guide portion 170.

The reflective surface 173 includes an upper reflective surface 173a and a lower reflective surface 173b, which are arranged to be separated a predetermined distance from each other and to face each other. Further, the reflective surface 173 includes first and second rear reflective surfaces 173c and 173d, which are arranged to be inclined with respect to the light exit surfaces 175a and 175b, respectively.

The distance between the upper reflective surface 173a and the lower reflective surface 173b is substantially the same as the thickness of the light guide panel 160. One side of each of the first and second rear reflective surfaces 173c and 173d, respectively, contacts the first and second light incident surfaces 171a and 171b, respectively. Moreover, the other side of each of the first and second rear reflective surfaces 173c and 173d, respectively, contacts the first and second light exit surfaces 175a and 175b, respectively.

First and second reflective members 191 and 195 for reflecting the light incident from the inside of the guide portion 170 are further provided on outer sides of the first and second rear reflective surfaces 173c and 173d, respectively.

Assuming that an angle between the first rear reflective surface 173c and the first light exit surface 175a, and that an angle between the second rear reflective surface 173d and the second light exit surface 175b are both θ₄, the angle θ₄ is about 19°.

When the angles θ₃ and θ₄ are set to be greatly out of set values, the light that is incident on the light guide panel 160 is divergent, or the light reflected by the first and second rear reflective surfaces 173c and 173d is reflected back to the light source 150.

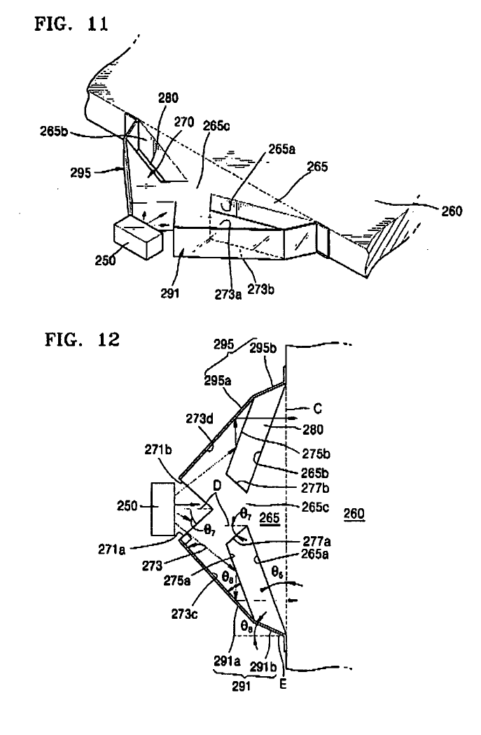

FIG. 11 and 12 are a perspective view and a plan view, respectively, illustrating major parts of a backlight unit according to a third exemplary embodiment of the present invention. Referring to FIG. 11 and FIG. 12, a backlight unit according to the third exemplary embodiment of the present invention includes at least one light source 250, a light guide panel 260 for guiding the light that is incident on one side surface thereof, a light incident portion 265 provided at one side surface of the light guide panel 260, a guide portion 270 provided between the light incident portion 265 and the light source 250, and first and second reflective members 291 and 295 provided around the guide portion 270 and the light incident portion 265. Since the light source 250 and the light guide panel 260 are substantially the same as the light source 50 of FIG. 7 and the light guide panel 60 of FIG. 7, according to the first exemplary embodiment of the present invention, respectively, detailed descriptions thereof will be omitted herein.

The light incident portion 265 and the guide portion 270 condense the light that is emitted from the light source 250 and that is incident on the light guide panel 260, so as to decrease an azimuth angle of the light in the light guide panel 260.

To this end, the light incident portion 265 protrudes to be inclined with respect to one side of the light guide panel 260 on which light is incident and has third and fourth light incident surfaces 265a and 265b, which are arranged to be separated a predetermined distance from each other. An angle θ₅ between a segment C, which extends from the side surface of the light guide panel 260 where the light incident portion 265 is formed, and each of the third and fourth light incident surfaces 265a and 265b is about 20°. The angle is set considering the direction of the light reflected by the guide portion 270 so that the light that is incident on the light incident portion 265 is focused.

The guide portion 270 is integrally formed with the light incident portion 265 through a connection portion 265c, which is between the third light incident surface 265a and the fourth light incident surface 265b. The guide portion 270 is separated a predetermined distance from each of the third and fourth light incident surfaces 265a and 265b. Moreover, the guide portion 270 and each of the respective third and fourth light incident surfaces 265a and 265b face each other. The guide portion 270, configured as set forth above, guides the light that is emitted from the light source 250 to be incident on each of the third and fourth light incident surfaces 265a and 265b. When the light guide panel 260 and the guide portion 270 are integrally manufactured, to facilitate formation of an air gap 280, the air gap 280 is sufficiently separated as shown in FIG. 11 and FIG. 12.

The guide portion 270 includes first and second light incident surfaces 271a and 271b, which are installed to face the light source 250. The guide portion 270 also includes a reflective surface 273, light exit surfaces 275a and 275b, and first and second support surfaces 277a and 277b. The light exit surfaces 275a and 275b are arranged to face the third and fourth light incident surfaces 265a and 265b, respectively. The light that is emitted from the light source 250 passes through the first and second light incident surfaces 271a and 271b and propagates in the guide portion 170. The reflective surface 273 alters the direction of the incident light to proceed toward the third and fourth light incident surfaces 265a and 265b.

The first and second light exit surfaces 275a and 275b reflect the light that is directly incident from the first and second light incident surfaces 271a and 271b and output the light incident via the reflection surface 273 toward the light incident portion 265. That is, the light that is directly incident from the first and second light incident surfaces 271a and 271b, which is incident at an angle greater than the critical angle with respect to each of the first and second light exit surfaces 275a and 275b, is totally reflected by the first and second light exit surfaces 275a and 275b due to a difference in the refractive index between the air gap 280 and the guide portion 270.

The first and second support surfaces 277a and 277b are arranged in parallel with the first and second light incident surfaces 271a and 271b, respectively, and connect an end portion of each of the third and fourth light incident surfaces 265a and 265b and an end portion of each of the first and second light exit surfaces 275a and 275b, respectively.

The reflective surface 273 includes an upper reflective surface 273a and a lower reflective surface 273b, which are arranged to be separated a predetermined distance from each other and are arranged to face each other. The reflective surface 273 also includes first and second rear reflective surfaces 273c and 273d, which are arranged to be inclined with respect to the light exit surfaces 275a and 275b, respectively.

One side of each of the first and second rear reflective surfaces 273c and 273d, respectively, contacts each of the first and second light incident surfaces 271a and 271b, respectively. Further, the other side of the first and second rear reflective surfaces 273c and 273d, respectively, contacts each of the first and second light exit surfaces 275a and 275b, respectively. Assuming that an angle between the first rear reflective surface 273c and the first light exit surface 275a, and the angle between the second rear reflective surface 273d and the second light exit surface 275b are both θ₆, the angle θ₆ is about 22°.

Also, an angle θ₇ between a segment D, which is orthogonal to the segment C, and the first light incident surface 271a is the same as an angle θ₇ between the segment D and the first support surface 277a. As shown in FIG. 12, for instance, the angle θ₇ is about 42°. That is, the angle between the first light incident surface 271a and the second light incident surface 271b is about 84°, which is twice the angle θ₇.

The first and second reflective members 291 and 295 include first reflective portions 291a and 295a, which are formed on outer sides of the guide member 270. That is, the first and second reflective members 291 and 295 include an outer surface of each of the first and second rear reflective surfaces 273c and 273d, and second reflective portions 291b and 295b disposed outside of the air gap 280, respectively. The first and second reflective members 291 and 295 prevent the light incident from the inside of the guide portion 270 and the light passing through the air gap 280 from being out of a predetermined radiation angle.

Assuming that the angle between a segment E, which is orthogonal to the segment C, and the second reflective portions 291b and 295b is θ₈, the angle θ₈ is about 24°.

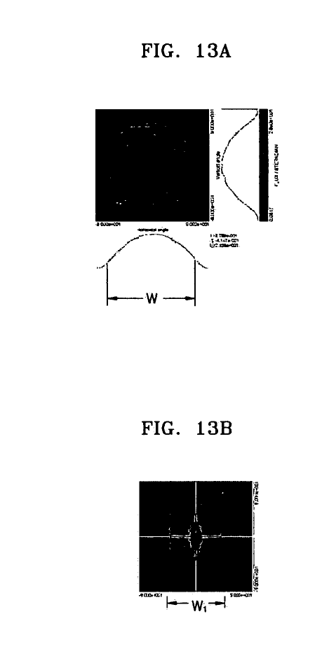

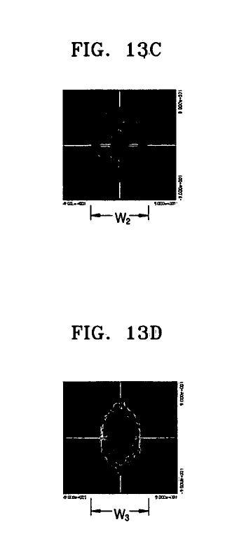

The angles θ₅, θ₆, θ₇, and θ₈ are set such that the radiation angle of the light that is incident on the light guide panel 260 does not decrease, as shown in FIG. 13D, and such that the light that is emitted from the light source 250 is not reflected back.

FIG. 13A, FIG. 13B, FIG. 13C and FIG. 13D are images showing a collimating performance of the backlight units according to a comparative example and the first, second and third exemplary embodiments of the present invention, respectively.

FIG. 13A, shows the shape of a section of the light that is emitted from a backlight unit according to a comparative example, which has a circular beam profile in which the width W in the horizontal direction is similar to the width in the vertical direction.

FIG. 13B, FIG. 13C, and FIG. 13D show the shape of a section of the light that is emitted from a backlight unit according to the first, second and third exemplary embodiments of the present invention, respectively. As shown in FIG. 13B, FIG. 13C, and FIG. 13D, the width in the horizontal direction is narrower than that in the vertical direction. The widths W₁, W₂, and W₃ in the horizontal direction are less than the width W of the comparative example. Thus, the collimating performance of the light that is emitted to a display via the light guide panel is improved so that an azimuth angle of the light transmitted in the light guide panel can be decreased.

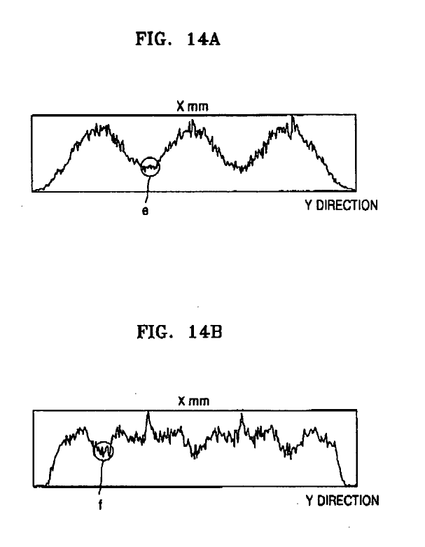

FIG. 14A and FIG. 14B are graphs showing the uniformity of the comparative example and the backlight units according to the third exemplary embodiment of the present invention, respectively. In the drawings, a case having three light sources and light incident portions are shown as an example.

Referring to FIG. 14A, the light that is emitted from each of the light sources has a Gaussian distribution and the intensity of the light is remarkably reduced at a region E, which represents a boundary between the respective light profiles.

Referring to FIG. 14B, which represents the light that is emitted from the backlight unit according to the third exemplary embodiment of the present invention, although the intensity of the light is reduced at a boundary region F, since the light intensity is greater than that of the comparative example, the uniformity of the light is improved.

As described above, as the azimuth angle of the light that is incident on the light guide panel 60 decreases, since the light is incident on the hologram pattern 61 at an angle close to 90°, light can be output with a high efficiency. Also, since the distribution of an azimuth angle of the light that is incident on the hologram pattern 61 becomes uniform, the distribution of an azimuth angle of the light output from the light guide panel 60 is uniform, so that the uniformity of luminance is improved.

As described above, in the backlight unit configured according to exemplary embodiments of the present invention, by decreasing the distribution of an azimuth angle of the light that is incident on the light guide panel, the efficiency of light output to a display device can be improved. Furthermore, since the distribution of the intensity of the output light becomes uniform, the uniformity in luminance on the light exit surface can be improved.

While this invention has been particularly shown and described with reference to exemplary embodiments thereof, it will be understood by those skilled in the art that various changes in form and details may be made therein without departing from the spirit and scope of the embodiments of the present invention as defined by the appended claims.

What is claimed is:

1. A backlight unit comprising:
at least one light source, which emits light;
a light guide panel, which guides light that is incident to a side surface of the light guide panel;
a light incident portion, which is inclined with respect to the side surface of the light guide panel, and which comprises a third light incident surface on which light is incident and a fourth light incident surface on which light is incident;
a first guide member, which is arranged to face the third light incident surface, and which guides light that is emitted from the light source to be incident on the third light incident surface; and
a second guide member, which is arranged to face the fourth light incident surface, and which guides light that is emitted from the light source to be incident on the fourth light incident surface,
wherein a first air gap is formed between the third light incident surface and the first guide member, and
wherein a second air gap is formed between the fourth light incident surface and the second guide member.

2. The backlight unit as claimed in claim 1, wherein a first angle between an imaginary line segment, which extends along a same plane as a side surface of the light guide panel at which the light incident portion is formed, and the third light incident surface is substantially 21°, and
wherein a second angle between the imaginary line segment and the fourth light incident surface is substantially 21°.

3. The backlight unit as claimed in claim 1, wherein the first guide member comprises:
a first light incident surface on which light that is emitted from the light source is incident;
a first reflective surface, which reflects incident light toward the third light incident surface; and
a first light exit surface, which is arranged to face the third light incident surface, which reflects light that is directly incident from the first light incident surface, and which transmits light that is incident from the first reflective surface toward the light incident portion, and
wherein the second guide member comprises:
a second light incident surface on which light that is emitted from the light source is incident;
a second reflective surface, which reflects incident light toward the fourth light incident surface; and
a second light exit surface, which is arranged to face the fourth light incident surface, which reflects light that is directly incident from the second light incident surface, and which transmits light that is incident from the second reflective surface toward the light incident portion.

4. The backlight unit as claimed in claim 3, wherein each of the first reflective surface and the second reflective surface comprises an upper reflective surface and a lower reflective surface, which are arranged to be separated a predetermined distance from each other, and which are arranged to face each other,
wherein the first reflective surface comprises a first rear reflective surface, which is arranged to be inclined with respect to the first light exit surface, and
wherein the second reflective surface comprises a second rear reflective surface, which is arranged to be inclined with respect to the second light exit surface.

5. The backlight unit as claimed in claim 4, further comprising:
a first reflective member, which is formed on an outer side of the first rear reflective surface, and which reflects light that is incident from inside the first guide member; and
a second reflective member, which is formed on an outer side of the second rear reflective surface, and which reflects light that is incident from inside the second guide member.

6. The backlight unit as claimed in claim 4, wherein a first angle between the first rear reflective surface and the first light exit surface is substantially 21°, and
wherein a second angle between the second rear reflective surface and the second light exit surface is substantially 21°.

7. A backlight unit comprising:
at least one light source, which emits light;
a light guide panel, which guides light that is incident to a side surface of the light guide panel;
a light incident portion, which is inclined with respect to the side surface of the light guide panel, and which comprises a third light incident surface and a fourth light incident surface, which are arranged to be separated a predetermined distance from each other; and
a guide portion, which is integrally formed with the light incident portion via a connection portion, which is between the third light incident surface and the fourth light incident surface,
wherein the guide portion is arranged to face each of the respective third light incident surface and the fourth light incident surface,
wherein the guide portion is separated from the third light incident surface by a first predetermined air gap,
wherein the guide portion is separated from the fourth light incident surface by a second predetermined air gap, and
wherein the guide portion guides light that is emitted from the light source to be incident on the light guide panel.

8. The backlight unit as claimed in claim 7, wherein a first angle between an imaginary line segment, which extends along a same plane as a side surface of the light guide panel at which the light incident portion is formed, and the third light incident surface is substantially 32°,
and wherein a second angle between the imaginary line segment and the fourth light incident surface is substantially 32°.

9. The backlight unit as claimed in claim 7, wherein the guide portion comprises:
a first light incident surface on which light that is emitted from the light source is incident;
a second light incident surface on which light that is emitted from the light source is incident;
a reflective surface, which reflects incident light toward the third light incident surface or the fourth light incident surface;
a first light exit surface;
and a second light exit surface,
wherein the first light exit surface and the third light incident surface are arranged to face each other;
wherein the second light exit surface and the fourth light incident surface are arranged to face each other;
wherein the first light exit surface is separated from the third light incident surface by a predetermined distance equivalent to a width of a first air gap,
wherein the second light exit surface is separated from the fourth light incident surface by a predetermined distance equivalent to a width of a second air gap,
wherein the first light exit surface reflects light that is directly incident from the first light incident surface, and transmits light that is incident via the reflective surface toward the light incident portion, and
wherein the second light exit surface reflects light that is directly incident from the second light incident surface, and transmits light that is incident via the reflective surface toward the light incident portion.

10. The backlight unit as claimed in claim 9, wherein the reflective surface comprises:
an upper reflective surface and a lower reflective surface, which are arranged to be separated a predetermined distance from each other, and which are arranged to face each other;
a first rear reflective surface, which is arranged to be inclined with respect to the first light exit surface; and
a second rear reflective surface, which is arranged to be inclined with respect to the second light exit surface.

11. The backlight unit as claimed in claim 10, further comprising a first reflective member and a second reflective member, which are formed on outer sides of the first rear reflective surface and the second rear reflective surface, respectively, and which reflect light that is incident from inside of the guide portion.

12. The backlight unit as claimed in claim 10, wherein a first angle between the first rear reflective surface and the first light exit surface, and a second angle between the second rear reflective surface and the second light exit surface, are substantially 19°.

13. A backlight unit comprising:
at least one light source, which emits light;
a light guide panel, which guides light that is incident to a side surface of the light guide panel;
a light incident portion, which is inclined with respect to the side surface of the light guide panel, and which comprises a third light incident surface and a fourth light incident surface, which are arranged to be separated a predetermined distance from each other;
a guide portion, which is integrally formed with the light incident portion, and which is arranged to face each of the third and the fourth light incident surfaces by being separated a predetermined distance therefrom, and which guides light that is emitted from the light source to be incident on the light guide panel;
a first reflective member comprising:
a first reflective portion, which is formed on an outer side of the guide portion; and
a second reflective portion, which is disposed on an outer side of a first gap between the third light incident surface and the guide portion; and
a second reflective member comprising:
a third reflective portion, which is formed on an outer side of the guide portion; and
a fourth reflective portion, which is disposed on an outer side of a second gap between the fourth light incident surface and the guide portion.

14. The backlight unit as claimed in claim 13, wherein a first angle between an imaginary line segment, which extends along a same plane as a side surface of the light guide panel at which the light incident portion is formed, and the third light incident surface is substantially 20°, and
wherein a second angle between the imaginary line segment and the fourth light incident surface is substantially 20°.

15. The backlight unit as claimed in claim 13, wherein an angle between an imaginary line segment, which is perpendicular to a side surface of the light guide panel at which the light incident portion is formed, and the second reflective portion is substantially 24°; and
an angle between the imaginary line segment and the fourth reflective portion is substantially 24°.

16. The backlight unit as claimed in claim 13, wherein the guide portion comprises:
a first light incident surface on which light emitted from the light source is incident;
a second light incident surface on which light emitted from the light source is incident;
a reflective surface, which reflects incident light toward a third light incident surface or a fourth light incident surface;
a first light exit surface, wherein the first light exit surface and the third light incident surface are arranged to face each other by being separated a predetermined distance from each other, and wherein the first light exit surface reflects light that is directly incident from the first light incident surface and transmits light that is incident via the reflective surface toward the light incident portion;
a second light exit surface, wherein the second light exit surface and the fourth light incident surface are arranged to face each other by being separated a predetermined distance from each other, and wherein the second light exit surface reflects light that is directly incident from the second light incident surface and transmits light that is incident via the reflective surface toward the light incident portion;
a first support surface, which is arranged parallel to the first light incident surface, and which connects an end portion of the third light incident surface and an end portion of the first light exit surface; and
a second support surface, which is arranged parallel to the second light incident surface, and which connects an end portion of the fourth light incident surface and an end portion of the second light exit surface.

17. The backlight unit as claimed in claim 16, wherein the reflective surface comprises:
an upper reflective surface and a lower reflective surface, which are arranged to be separated a predetermined distance from each other, and which are arranged to face each other; and
a first rear reflective surface and a second rear reflective surface, which are arranged to be inclined with respect to the first light exit surface and the second light exit surface, respectively.

18. The backlight unit as claimed in claim 17, wherein a first angle between the first rear reflective surface and the first light exit surface, and a second angle between the second rear reflective surface and the second light exit surface, are substantially 22°.

19. The backlight unit as claimed in claim 16, wherein an angle between the first light incident surface and the second light incident surface is substantially 84°.
